(19) United States
(12) Patent Application Publication
(10) Pub. No.: US 2008/0019867 A1
(43) Pub. Date: Jan. 24, 2008

(54) Urinalysis screening device

(76) Inventors: Paul K. Johnson, Blue Earth, MN (US); Carolyn J. Cooper, Mt. Vernon, IA (US); Sarah Kolar, Mt Vernon, IA (US); Robert Morphew, Placerville, CA (US); Richard Strasser, Auburn, CA (US)

Correspondence Address: Paul R. Martin, 2291 Bennington Drive, Vallejo, CA, 94591, US

(21) Appl. No.: 11/582,762

(22) Filed: Oct. 19, 2006

Related U.S. Application Data
(60) Provisional application No. 60/832,824, filed on Jul. 22, 2006.

(51) Int. Cl. G01N 31/22

(52) U.S. Cl. 422/58

(57) ABSTRACT

A urinalysis screening device is disclosed that comprises a container, a cap for the container which seals in the urine sample, and an assay assembly that fits into the container. The assay assembly contains a plurality of diagnostic strips that enables the urine to be analyzed for various substances

This application claims priority based on Provisional Patent Application Ser. No. 60/832,824, filed Jul. 22, 2006, entitled: Urinalysis Screening Device.

### BACKGROUND OF THE INVENTION

1. Field of the Invention

This invention relates to a urinalysis screening device, and particularly to an screening device that is useful as a diagnostic tool to detect the presence of drugs, hormones, metabolites, pathogens, or other substances of interest in urine. The device may also be referred to as a screening kit.

2. Prior Art

In the modern business and sports world, job applicants or sports participants are often tested for the presence of drugs, or other prohibited substances. For example, professional baseball and football players are subject to random testing to detect the presence of such substances as drugs or human growth hormone. This is conventionally done by urinalysis. It is desirable to be able to take a urine sample at the location where the participant is found, such as a sports stadium or playing field.

In the business world, prior to being offered a job, applicants are tested for the presence of marijuana, cocaine and like substances. It is desirable to have a quick and easy way to collect a urine sample, and, hopefully, be able to analysis the urine instantaneously to detect the presence of prohibited substances.

Urine assay devices are known in the art. For example, U.S. Pat. Nos. 6,805,837, and 6,805,838 describe and claim assaying devices for collecting specimens of urine in the field. U.S. Pat. Nos. 6,379,620 and 6,548,019 also show and claim devices for assaying urine and biological fluids in the field. The devices shown in these patents are complex, and relatively expensive to make. Less expensive and simpler devices are constantly being sought.

The present invention differs from the assay device shown in the foregoing patents, in a number of ways, which make it easier and less expensive to manufacture, as will be seen from the description below.

### SUMMARY OF THE INVENTION

It is an object of the invention to provide as a urinalysis screening device or kit which overcomes the disadvantages of the devices of the prior art.

It is a further object of the invention to provide an inexpensive urinalysis screening device or kit which is suitable for use in in-situ urine analysis.

Other objects and advantages of the present invention will be apparent from the description below.

In general, the urinalysis screening device or kit of the present invention comprises a container, a cap for the container which seals in the urine sample, and an assay assembly that fits into the container. The assay assembly contains a plurality of diagnostic strips that enables the urine to be analyzed for various substances

### BRIEF DESCRIPTION OF THE DRAWINGS

The above mentioned features and objects of the present invention will become apparent with reference to the following description taken in conjunction with the accompanying drawings wherein like reference numerals denote like elements and in which:

FIG. 1 is a side view of the urinalysis screening device of the invention.

FIG. 2 is a perspective view of the assay assembly that is a component of the urinalysis screening device of the invention.

FIG. 3 is an exploded view of the assay assembly of the invention, showing the plastic cover that fits over the diagnostic strips.

FIG. 4 is a close up cross sectional view of the diagnostic strip support plate forming a part of the assay assembly of the invention.

FIG. 5 is a perspective view of the urinalysis screening device of the invention with parts broken away to show the assay assembly of the invention seated within the container.

FIG. 6 is a side view of the urinalysis screening device of the invention showing a removable label on the outside of the container for obscuring the results of the test being conducted until the label is removed.

FIG. 7 is a perspective view of the bottom surface of the cap for the urine container, showing the sealing ring to prevent urine from escaping from the container during transportation.

### DETAILED DESCRIPTION OF THE INVENTION

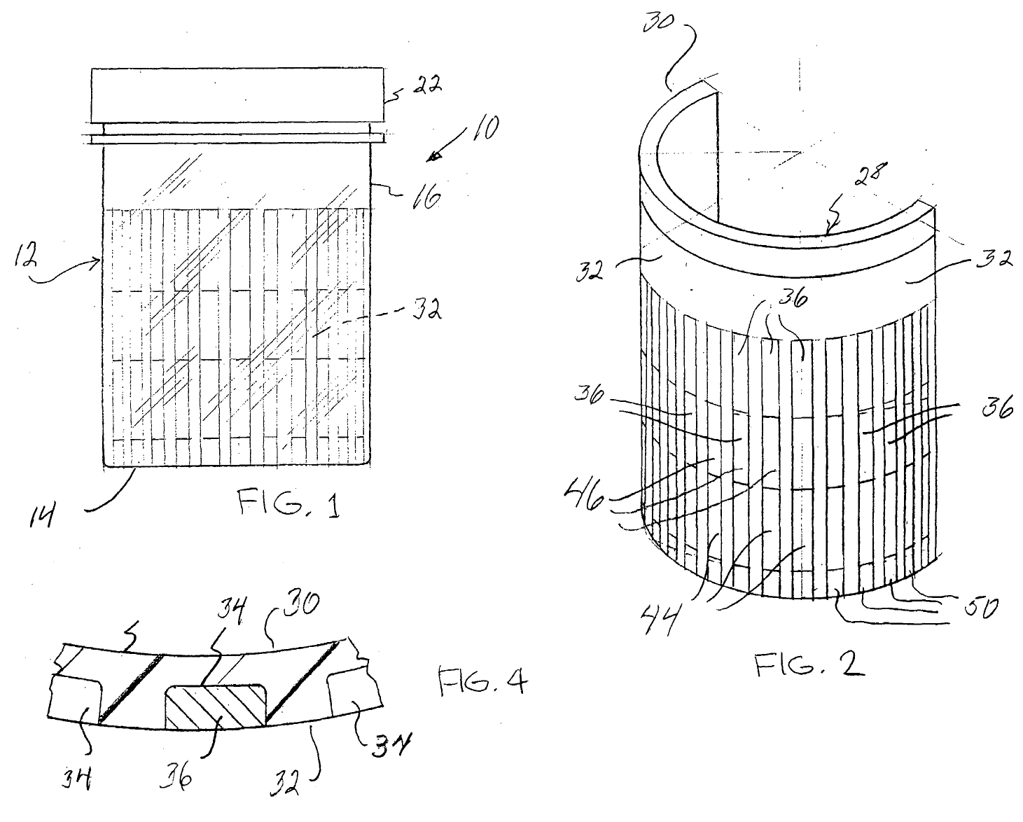

As seen in FIGS. 1, and 5, the urinalysis screening device 10 of this invention comprises a container 12, also referred to as a cup, having a circular, flat bottom 14, curved vertical walls 16 and open top, or mouth 18. The container 12 is preferably made of a rigid plastic, but can also be made of glass. Threads 20 for receiving a closure are molded into the outer surface of the walls 16 at the upper end thereof, and surround the mouth 18 of the container 12. A closure or cap 22, also having threads 24 on the inside thereof which are complementary to the threads 20 around the mouth 18 of the container 12, screws onto the mouth 18 of the container 12. The cap 22, preferably made of plastic, has a rubber like sealant ring 26 on the inside surface that comes into contact with upper edges of the walls 16 of the container 12 when the cap 22 is screwed on, thus making it fluid tight. The cap 22 is preferably made of plastic, preferably polypropylene, but can be of any substance such as metal or similar material. The sealant ring 26 on the inside periphery of the cap 22 is preferably made of rubber, but can also be made of a rubber like material, such as rubberized silicone. As seen in FIG. 5, the walls 16 of the container 12 form a complete circle. In a preferred embodiment of the urinalysis screening device 10 of the invention, the container 12 is approximately 2 inches in diameter, and the walls 16 about 3.2 inches high. The container holds about 8 ounces of fluid. Plastic containers of the type described above can be purchased from Oocott Plastics, St. Charles, Ill. 60174-6042.

Positioned inside the container 12 is a diagnostic test strip assembly 28, also called a cup insert. The assembly 28 comprises an arcuate diagnostic test strip support plate 30 having a curvature that is adapted to conform to the inside surface of the walls 16 of the container 12. The support plate 30 is made of a plastic material that is rigid, but has some flexibility. A support plate made of polystyrene is preferred. Thus, when introduced into the container 12, the support plate 30 flexes outward so that the outer surfaces 32 of the support plate 30 closely align with and abut the inside surfaces of the container walls 16. The support plate 30 occupies about ½ of the total surface area of the inside periphery of the container 12.

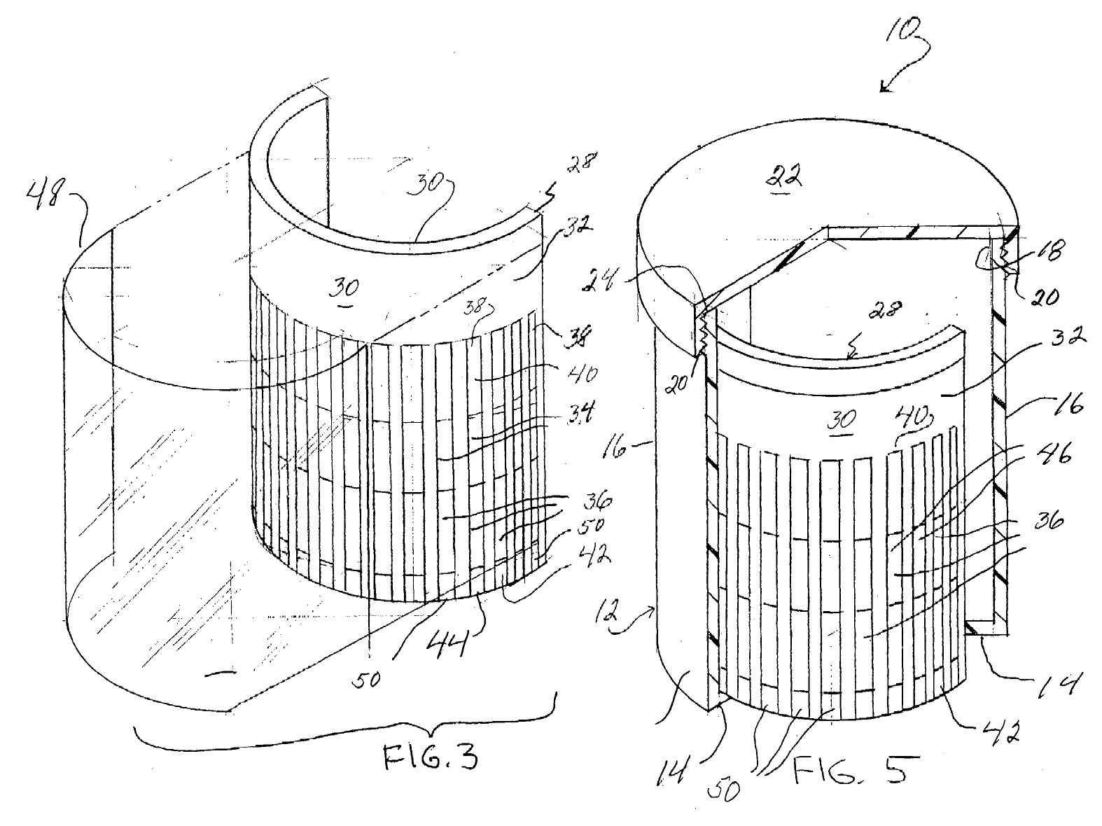

As best seen in FIGS. 2 and 3 the support plate 30 has a plurality of spaced apart indentations or grooves 34 in it which extend from the bottom edge of the plate 30 to a point about ¾ of the height of the plate. In a preferred embodiment, the plate is about 0.060 inches thick, the grooves are about 0.005 inches deep, about 0.150 inches wide, and spaced apart from each other about 0.76 inches. A plurality of diagnostic test strips 36 are positioned in the grooves 34, one to each groove. The diagnostic test strips 36 are capable of detecting a variety of substances in urine, such as marijuana, cocaine, amphetamine, barbiturate, benzodiazepine, ecstasy, methadone, methamphetamine, opiates, metabolites, propoxyphene, phencyclidine, tricyclic antidepressants, oxycodone, specimen adulterants, and alcohol. The test strips are available commercially, and can be purchased from W.H.P.M, Inc, El Monte, Calif. . . . Each test strip 36 comprises a backing 38, having an upper 40 and lower 42 end. A wicking material 44 is positioned on the lower end 42 of the backing, and a reactive membrane 46 on the upper end 44 of the backing material . . . . The wicking material 44 serves to wick urine into the reactive membrane section 46 of each strip. The wicking material 44 can be made of any material that will wick up a liquid such as filter paper, unwoven papers, fiber glass and the like. Each reactive membrane 46 contains a chemical substance that reacts with a specific drug or other substance in the urine. Such test strips as have been described are well known to those skilled in the art.

A clear plastic cover sheet 48 is bonded to the outer exposed surfaces 32 of the support plate 30, and covers the test strips 36, except for a section 50 at the very bottom thereof which contains exposed wicking material 44. Thus each test strip 36 situated within a groove 34 is sealed off or isolated from adjacent test strips by the plastic cover 48 bonded to the exposed surfaces 32 of the support plate 30, including those surfaces separating each test strip 36, thereby preventing contamination of a specific test strip from adjacent test strips. The plastic sheet 48 is preferably made of polyester and is bonded to the available surfaces of the support plate 30 by means of an acrylic sealant. It is bonded to the support plate 30 after the diagnostic test strips 36 are placed in the grooves 34.

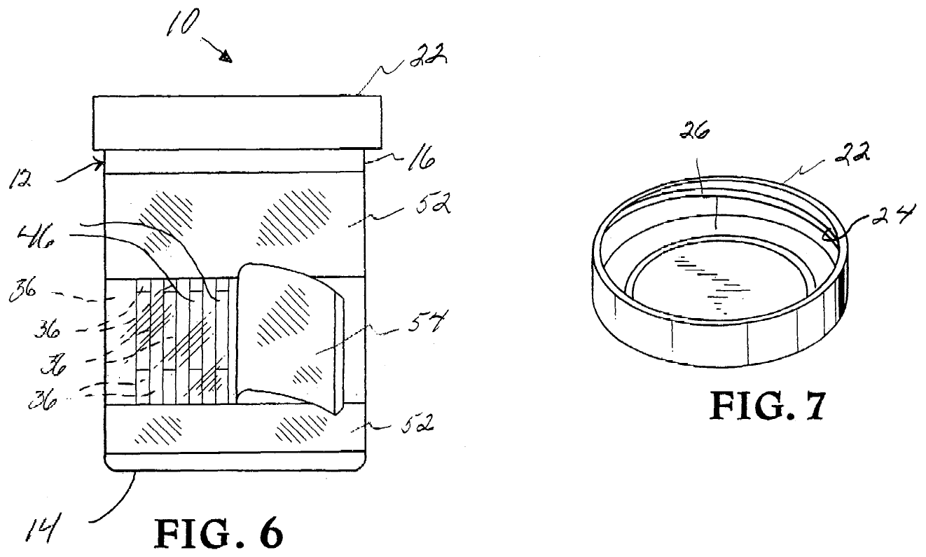

In a preferred embodiment of the invention, as seen in FIG. 6, the container 12 has a label 52 affixed to the outside wall surface thereof, and is coextensive with the exposed area of the support plate 30 inside the container 12. The label 52 has a removable tab 54 which overlies the section of the assay assembly 28 providing the results of the urinanalysis, thus preventing an individual from reading the results unless the tab 54 is removed. This provides a level of privacy to the individual donating the urine specimen.

The label 52 can also contain information on how to read the diagnostic test strips 36. For example, if two lines are visible on the diagnostic strip 36, the test result is negative. If any one or more of the diagnostic strips 36 has just one line at the top, it is “presumptive” positive. If no lines are present on a test strip 36, or a line on the bottom is present, then the test is considered invalid or not working. This information can be placed on the label to assist the reader in interpreting the results of the tests.

The principle of operation is that each user voids a specimen into the container 12 and then screws the cap 22 onto it, thus sealing the urine specimen in the container. The urine specimen is then wicked up through the exposed portion 50 of the wick 44 found on the bottom of each test strip 36. Wicking is ensured by sealing the diagnostic test strip 36 in the groove 34 that is surrounded on three sides by the support plate 30 and a clear polyester cover 48 over the front of the support plate 30, and bonded to all exposed surfaces of the support plate 30. The sealing of this test strip 36 on all four sides creates a chamber that utilizes atmospheric pressure inside the chamber to prevent the specimen material from flooding over the test. The specimen material is then forced to wick up to the diagnostic membrane 46 from the base of the container 12 through the exposed wick 50 of the diagnostic strip 36. The specimen fluid cannot wick down from the top of the container, as the grooves 34 in the support plate 30 do not extend all the way to the top, rather only about ¾ of the way. The diagnostic test strips 36 are thus sealed off from the atmosphere at their tops by the body of the support plate 30 and plastic cover 48 overlying them.

After approximately three minutes, the removable tab 54 of the container label 52 is removed to reveal the results of the test. Temperature indicating dots are incorporated in the label 52 to help verify that the sample has not been substituted. A freshly voided urine sample should indicate a temperature between 92 degrees F. and 100 degrees F. Adulteration indicators can be added to the label 52 or assay assembly 28 to indicate if a given specimen sample has been adulterated.

If a positive result is indicated on the test, the device with urine sample inside is sent to a laboratory for final confirmation.

It should be apparent to those skilled in the art, that while the invention described herein, has been described in terms of a urinalysis screening device, or urinalysis screening test kit, that the same physical device can be use for screening other fluid materials where the fluid can be exposed to reactive strips that indicate whether or not certain substances are contained in the specimen being tested. The above described embodiments are simply illustrative of those embodiments that could be created by one skilled in the art without departing from the spirit and scope of the invention described herein.

We claim:

1. A urinalysis screening device comprising:
a. a transparent container having a top and a bottom, vertical walls intermediate said top and bottom, and a mouth at the top thereof for receiving a sample,
b. a fluid tight closure for the container,
c. an assay assembly situated within the container comprising a diagnostic assay strip support plate adapted to conform to a portion the inside surface of the container, said support plate having a plurality of spaced apart vertical grooves in it, a plurality of diagnostic assay strips situated in said plurality of vertical grooves, and a transparent plastic sheet overlying said assay strips and bonded to said support plate, said transparent plastic sheet covering all of the surface of said diagnostic assay strips except at the lower ends thereof, whereby when urine is introduced into said container, it comes into contact with the lower ends of said assay strips, and wicks itself up to the reactive portion of said diagnostic assay strips, said diagnostic assay strips then indicating the presence of one or more substances of interest.

2. The device of claim 1 wherein said container is a round polystyrene plastic cup having a mouth at the top, and screw threads around the outside of the mouth.

3. The device of claim 1 wherein said fluid tight closure is a polypropylene cap having a rubber strip around the periphery of the inside of the cap that comes into contact with the mouth of said container when the cap is screwed onto the mouth of said container.

4. The device of claim 1 wherein said diagnostic assay strip support plate is made of a substantially rigid plastic, and is of a size that allows it to conform within about one half of the inner surface of the walls of said container.

5. The device of claim 4 wherein said support plate is made of styrene.

6. The device of claim 1 wherein said diagnostic assay strips test for at least one of marijuana, cocaine, amphetamine, barbiturate, benzodiazepine, ecstasy, methadone, methamphetamine, opiates, propoxyphene, phencyclidine, tricyclic antidepressants, oxycodone, specimen adulterants, and alcohol.

7. The device of claim 1 which further has a removable label on the outside of the container covering an area substantially equivalent to the area of the diagnostic assay strip support plate, thereby obscuring the results of said diagnostic tests until the portion of said label overlying the reactive portion of said diagnostic strips is removed.

8. The device of claim 6 wherein said removable label is made of polyester, and has temperature indicating dots on the surface thereof.

9. A urinalysis screening test kit comprising:
a. a transparent container having a top and a bottom, and a mouth at the top thereof for receiving a sample,
b. a fluid tight closure for the container, and
c. an assay assembly situated within the container comprising a diagnostic assay strip support plate adapted to conform to a portion the inside wall surface of the container, said support plate having a plurality of spaced apart vertical grooves in it, a plurality of diagnostic assay strips situated in said plurality of vertical grooves, and a transparent plastic sheet overlying said assay strips and bonded to said support plate, said transparent plastic sheet covering all of the surface of said diagnostic assay strips except at the lower ends thereof, whereby when urine is introduced into said container, it comes into contact with the lower ends of said assay strips, and wicks itself up to the reactive portion of said diagnostic assay strips, said diagnostic assay strips then indicating the presence of one or more substances of interest.

10. The test kit of claim 9 wherein said container is a round polystyrene plastic cup having a mouth at the top, and screw rings around the outside of the mouth.

11. The test kit of claim 9 wherein said fluid tight closure is a polypropylene cap having a rubber strip around the periphery of the inside of the cap that comes into contact with the mouth of said container when the cap is screwed onto the mouth of said container.

12. The test kit of claim 9 wherein said diagnostic assay strip support plate is made of a substantially rigid plastic, and is of a size that allows it to conform within about one half of the area of the inner surface of the walls of said container.

13. The device of claim 12 wherein said support plate is made of styrene.

14. The test kit of claim 9 wherein said diagnostic assay strips test for at least one of marijuana, cocaine, amphetamine, barbiturate, benzodiazepine, ecstasy, methadone, methamphetamine, opiates, propoxyphene, phencyclidine, tricyclic antidepressants, oxycodone, specimen adulterants, and alcohol.

15. The test kit of claim 9 which further has a removable label on the outside of the container covering an area substantially equivalent to the area of the diagnostic assay strip support plate, thereby obscuring the results of said diagnostic tests until the portion of said label overlying the reactive portion of said diagnostic strips is removed.

16. The device of claim 15 wherein said removable label is made of polyester, and has temperature indicating dots on the surface thereof.

17. The device of claim 1 wherein said diagnostic test strip comprises a backing, a wicking material attached to the backing at the lower end thereof, and a reactive material attached to the backing at the upper end thereof.

18. The urinalysis test kit of claim 9 wherein said diagnostic test strip comprises a backing, a wicking material attached to the backing at the lower end thereof, and a reactive material attached to the backing at the upper end thereof.
